(19) United States
(12) Patent Application Publication
(10) Pub. No.: US 2012/0196260 A1
(43) Pub. Date: Aug. 2, 2012

(54) Electronic Comic (E-Comic) Metadata Processing

(76) Inventor: Kao Nhiayi, San Diego, CA (US)

(21) Appl. No.: 13/018,675

(22) Filed: Feb. 1, 2011

(51) Int. Cl. G09B 5/00

(52) U.S. Cl. 434/317

(57) ABSTRACT

Text sections and each comic character within each of at least one scanned comic frame are identified. Text is captured from each of the identified text sections using optical character recognition (OCR) of each of the identified text sections. A sequence of the text sections is determined based upon grammatical conventions of a language within which the at least one scanned comic frame is presented. An audio output model is identified for each of the determined sequence of the text sections. The at least one scanned comic frame is stored with the captured text, the determined sequence of the text sections, and the identified audio output model for each of the determined sequence of the text sections. This abstract is not to be considered limiting, since other embodiments may deviate from the features described in this abstract.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

Traditional comic books are rendered on paper and are often appreciated by comic book collectors and other individuals for their story lines, characters, or method of graphical representation. These traditional comic books are sometimes out of print and their value may increase as supplies diminish.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a block diagram of an example of an implementation of a system for automated electronic comic (e-comic) metadata processing consistent with certain embodiments of the present invention.

FIG. 2 is a block diagram of an example of an implementation of an electronic comic rendering device that provides automated electronic comic (e-comic) metadata processing consistent with certain embodiments of the present invention.

FIG. 3 is a flow chart of an example of an implementation of a process that provides automated electronic comic (e-comic) metadata processing consistent with certain embodiments of the present invention.

FIG. 4A is a flow chart of an example of an implementation of initial processing within a process for automated electronic comic (e-comic) metadata processing consistent with certain embodiments of the present invention.

FIG. 4B is a flow chart of an example of an implementation of a first portion of additional processing within the process illustrated in FIG. 4A for automated electronic comic (e-comic) metadata processing consistent with certain embodiments of the present invention.

FIG. 4C is a flow chart of an example of an implementation of a second portion of additional processing within the process illustrated in FIG. 4A for automated electronic comic (e-comic) metadata processing consistent with certain embodiments of the present invention.

FIG. 4D is a flow chart of an example of an implementation of a third portion of additional processing within the process illustrated in FIG. 4A for automated electronic comic (e-comic) metadata processing consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “program” or “computer program” or similar terms, as used herein, is defined as a sequence of instructions designed for execution on a computer system. A “program,” or “computer program,” may include a subroutine, a function, a procedure, an object method, an object implementation, in an executable application, an applet, a servlet, a source code, an object code, a shared library/dynamic load library and/or other sequence of instructions designed for execution on a computer system having one or more processors.

Reference throughout this document to “one embodiment,” “certain embodiments,” “an embodiment,” “an implementation,” “an example” or similar terms means that a particular feature, structure, or characteristic described in connection with the example is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive.

The present subject matter provides automated electronic comic (e-comic) metadata processing. By use of the subject matter described herein, a paper comic may be scanned and preserved, and character-based audio output and other sound effects may be added to create an enhanced version of the comic utilizing the original graphic renderings captured in electronic format. Alternatively, a stored electronic comic may be processed to add character-based audio output and other sound effects. The automated e-comic metadata processing identifies text sections and each comic character within scanned comic frames. Text is extracted/captured, using optical character recognition (OCR), from each of the identified text sections of the comic pages/frames, such as, for example, storyboard pictures, character text bubbles, other text associated with comic characters, and printed indications of sound effects. The captured text from each of the identified text sections may be stored with character association information and/or with location information indicating where within a given area of a frame/page of the comic the processed text is located to form e-comic metadata. As such, each segment of captured text may be associated with a location within a printed page, and with a character for which the text is associated within a given comic frame or scene. When rendered, the e-comic metadata provides sequencing information and audio output generation information to enhance a viewing experience for the original comic.

Regarding the e-comic metadata, each identified area and captured text segment may further be automatically assigned an index number that provides sequence information for the captured text. A sequence of the text sections is determined based upon grammatical conventions of a language within which a scanned comic frame is presented. The sequence information allows sequencing of audio output in an order that is correlated with character text bubbles within the e-comic. An audio output model is identified for each of the sequence of the text sections and a character vocal output may be selected based upon the determined character trait of each comic character within the scanned comic frame for each of the determined sequence of the text sections. Using the association of the captured text with the character(s) and/or the sequence information, the captured text may be processed during electronic comic reading/rendering to generate audio output based upon the audio output model and the selected character vocal output associated with characters of the comic as a comic reader progresses sequentially through the story. A bubble associated with a respective portion of audio output may be highlighted as the reader progresses and audio output is generated. Further, where portions of the text are recognized as narrative, this content may also be differentiated with a different voice or modulation of audio output.

Each comic character or narration may be assigned a unique automated voice for spoken lines. Assigning a unique automated voice to each comic character and any narrated text allows role playing to be utilized and for voicing parts of a story associated with different characters. For example, a male voice may be generated for a male character, a female voice may be generated for a female character, a dog bark sound may be generated for a dog, etc. Vocal inflections in the automated voice output may also be generated based upon automated interpretation of the characters' spoken text. For example, where it is interpreted that a female character is smiling at a male character that is blushing, appropriate inflections in voice audio output may be generated to impart an effect of sweetness, shyness, or other emotion to a given character.

Sound effects may also be generated to further enhance a story. Sound effects may be selected from a sound effects library in response to identification of a sound within a captured text processing dictionary. For example, where a word “bang” is identified, this word may be cross-referenced within the captured text processing dictionary to a particular sound effect or set of sound effects. Where multiple sound effects are possible, one may be automatically selected and a user may be provided within an opportunity to select one or more additional sound effects for the sequence location of the given text within the comic. Where Internet connectivity is available to a given comic rendering device, a sound effects library and/or the captured text processing dictionary may be stored on a server accessible to a comic rendering device. Searches may be performed for additional effects via one or more additional sound effects libraries, and additional or alternative sound effects may be received and processed by the comic rendering device. Received sound effects may be stored locally to enhance a locally-stored sound effects library and captured text processing dictionary.

The sound effects library may also be cross-referenced with character action information. For example, music may be generated, such as for example suspenseful music when a comic character enters a dark tunnel or other suspenseful situation. Alternatively, a thump sound may be generated if a comic character falls down or jumps onto or off of, for example, a fence. Many other possibilities exist for sound effects generation in association with e-comic metadata processing and all are considered within the scope of the present subject matter. As such, using the subject matter described herein, traditional paper comics may be converted to e-comics, with audio output associated with the respective comic characters, narratives, scene situations, etc. Further, additional possibilities for enhancing imaginative aspects of a story and storytelling may be realized using the present subject matter.

It should be understood that the present subject matter applies to any form of paper comic or previously-captured electronic comic. As discussed above, each identified area and captured text segment may be automatically assigned an index number that provides sequence information for the captured text. These sequence numbers may be based upon grammatical conventions of a language within which the text of the comic is rendered. As such, for comics rendered in the English language, assignment of index numbers may be from left to right and top to bottom, according to English language grammatical conventions. Alternatively for Japanese comics (such as Mangas), the assignment of index numbers may be from right to left and top to bottom, according to Japanese language grammatical conventions. Many other possibilities exist for assignment of index numbers based upon the input paper comic format and all are considered within the scope of the present subject matter.

Using the location information, characteristics of a comic character or characteristics of a rendering device may be considered. For example, image shifting may be performed to emphasize a portion of a given frame or to bring a relevant portion of a frame into view on a small output display of a portable consumer electronics device. Also for example, in a scene where a male character is speaking within a comic frame and a determination is made from the captured text that a character is excited and may be yelling, such as upon arrival at home and seeing his dog running toward him, the output video may be shifted toward the male character to emphasize the character's actions and to provide motion to the output. Further, where the next sequential captured text is that of the dog barking, the output may be shifted toward the dog in association with output generation of a dog bark. Many other possibilities exist for use of location information in association with output generation and all are considered within the scope of the present subject matter.

Customization and editing of automatically generated audio output may also be performed. For example, both male and female voice types may be stored for a given character and a user may edit to select between the two. Alternatively, a generic voice may be generated and audio modulation may be used to distinguish between male and female characters.

The present subject matter may further be utilized as an interactive experience for teaching others, such as children and/or students, and may be utilized to improve reading skills and reading comprehension. Customized content for teaching purposes may be generated rapidly in either paper or electronic format, and scanned/processed in real-time or near real-time to generate electronic audio and video output. Additionally, the e-comic metadata may be generated by one device and stored into a file for other devices to render (no OCR processing or indexing). For such an implementation, less-sophisticated devices (or devices with fewer attributes, such as a reader device, a telephone/mobile phone, a television, or a tablet computing device) may be enabled to read the e-comic metadata generated by a more-sophisticated device. Further, such e-comic metadata files may be created by electronic comic (e-comic) metadata processing devices using, for example, data from content or computer vendors. Comic content encoded with e-comic metadata may be distributed by any suitable distribution system or approach, as appropriate for a given implementation (e.g., optical media distribution, downloads, etc.). Many other possibilities exist for generation and distribution of e-comics processed as described herein and all are considered within the scope of the present subject matter.

For purposes of the present description, the term “real time” shall include what is commonly termed “near real time”—generally meaning any time frame of sufficiently short duration as to provide reasonable response time for on demand information processing acceptable to a user of the subject matter described (e.g., within a few seconds or less than ten seconds, or within a minute or so in certain systems). These terms, while difficult to precisely define are well understood by those skilled in the art. It is further understood that the subject matter described herein may be performed in real time and/or near real time.

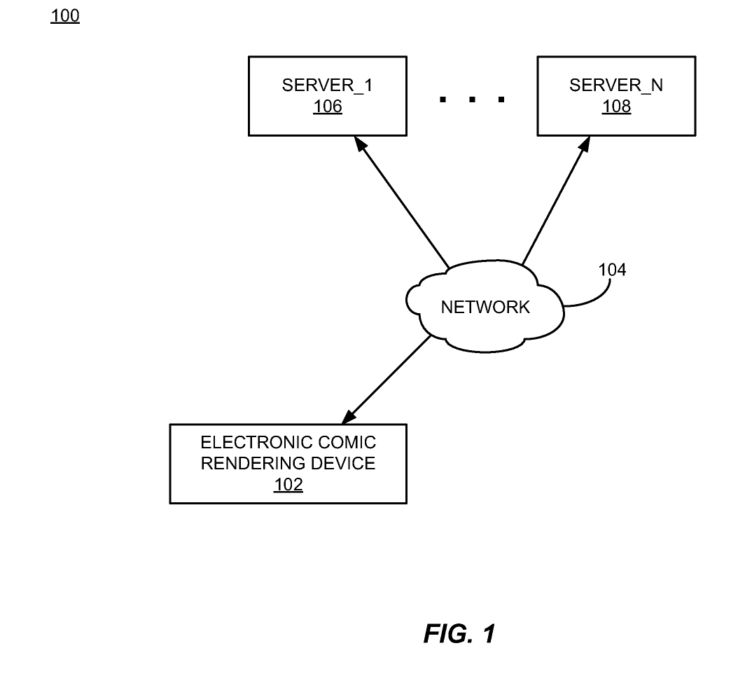

Turning now to FIG. 1, FIG. 1 is block diagram of an example of an implementation of a system 100 for automated electronic comic (e-comic) metadata processing. An electronic comic rendering device 102 interconnects via a network 104 with a server_1106 through a server_N 108. As will be described in more detail below, the electronic comic rendering device 102 provides automated electronic comic (e-comic) metadata processing. The electronic comic rendering device 102 allows a paper comic to be scanned and preserved, and character-based audio output and other effects may be added to create an enhanced version of the comic utilizing the original graphic renderings captured in electronic format. The server_1106 through the server_N 108 may include any network-based server accessible by the electronic comic rendering device 102 via a network such as the network 104. The server_1106 through the server_N 108 may provide access to sound effects libraries, character voice libraries, or other audio and/or video content for use by the electronic comic rendering device 102.

The network 104 may include any form of interconnection suitable for the intended purpose, including a private or public network such as an intranet or the Internet, respectively, direct inter-module interconnection, dial-up, wireless, or any other interconnection mechanism capable of allowing communication between devices. An example of a protocol suitable for providing communication over the network 104 is the transmission control protocol over Internet protocol (TCP/IP).

Markup language formatting, such as the hypertext transfer protocol (HTTP) and extensible markup language (XML) formatting, may be used for messaging over the TCP/IP connection with devices accessible via the network 104. Other web protocols exist and all are considered within the scope of the present subject matter. As described above, the server_1106 through the server_N 108 may be any device or Internet server or service that stores sound effects libraries, character voice libraries, or other audio and/or video content for use by a device such as the electronic comic rendering device 102.

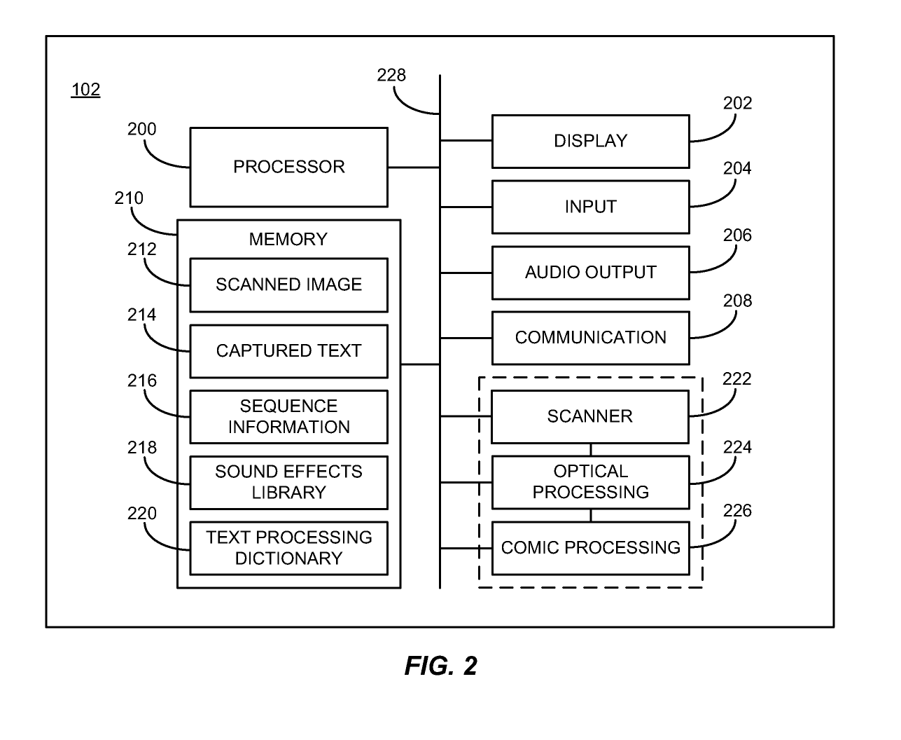

FIG. 2 is a block diagram of an example of an implementation of the electronic comic rendering device 102 that provides automated electronic comic (e-comic) metadata processing. A processor 200 provides computer instruction execution, computation, and other capabilities within the electronic comic rendering device 102. A display device 202 provides visual and/or other information to a user of the electronic comic rendering device 102. The display device 202 may include any type of display device, such as a cathode ray tube (CRT), liquid crystal display (LCD), light emitting diode (LED), electronic ink displays, projection or other display element or panel. An input device 204 provides input capabilities for the user. The input device 204 may include a mouse, pen, trackball, or other input device. One or more input devices, such as the input device 204, may be used.

An audio output device 206 provides audio output capabilities for the electronic comic rendering device 102, such as generated character voices for comic characters and generated sound effects. The audio output device 206 may include a speaker, driver circuitry, and interface circuitry as appropriate for a given implementation.

A communication module 208 provides communication capabilities for interaction with the electronic comic rendering device 102, such as for retrieval of character vocal output models (e.g., vocal envelopes, voice signatures, gender models, etc.) based upon the determined character traits of characters within one or more scanned comic frames, sound effects, and other activities as appropriate for a given implementation. The communication module 208 may support wired or wireless standards appropriate for a given implementation. Example wired standards include Internet video link (IVL) interconnection within a home network, for example, such as Sony Corporation's Bravia® Internet Video Link (BIVL™). Example wireless standards include cellular wireless communication and Bluetooth® wireless communication standards. Many other wired and wireless communication standards are possible and all are considered within the scope of the present subject matter.

It should be noted that the communication module 208 is illustrated as a component-level module for ease of illustration and description purposes. It is also understood that the communication module 208 may include any hardware, programmed processor(s), and memory used to carry out the functions of the communication module 208. For example, the communication module 208 may include additional controller circuitry in the form of application specific integrated circuits (ASICs), processors, antenna(s), and/or discrete integrated circuits and components for performing electrical control activities associated with the communication module 208. Additionally, the communication module 208 may include interrupt-level, stack-level, and application-level modules as appropriate. Furthermore, the communication module 208 may include any memory components used for storage, execution, and data processing by these modules for performing processing activities associated with the communication module 208. The communication module 208 may also form a portion of other circuitry described below without departure from the scope of the present subject matter.

A memory 210 includes a scanned image storage location 212 that organizes and stores scanned comic images/frames. The memory 210 also includes a captured text storage area 214 that stores text optical character recognition (OCR) processed and captured text within each text section of a scanned comic frame.

A sequence information storage area 216 stores determined sequences of text sections of scanned comic frames based upon a location of each text section within a given scanned comic frame. The sequence information may be determined in response to scanning a given image or frame of a comic or other printed matter and capturing text within the given image or frame via OCR processing. The determined sequence information may be stored for further processing and rendering of a given captured comic.

The determined sequence information may also be based upon grammatical conventions of a language of the text sections of scanned comic frames. For example, a grammatical convention for text sections of English language comics may include left-to-right followed by top-to-bottom sequencing of text sections within a given English language comic. Alternatively, a grammatical convention for text sections of Japanese language comics (e.g., Mangas) may include right-to-left followed by top-to-bottom sequencing of text sections. Many other possibilities exist for grammatical conventions for comic processing either based upon language or other convention and all are considered within the scope of the present subject matter.

A sound effects library storage area 218 may store one or more sound effects and sound effects libraries for use during electronic rendering of captured comics. The sound effects and sound effects libraries may be pre-stored within the electronic comic rendering device 102 or may be obtained from one or more of the server_1106 through the server_N 108, as appropriate for a given implementation.

A text processing dictionary storage area 220 may store one or more captured text processing dictionaries for identifying text within a determined sequence of the text sections within captured comics. A text processing dictionary may be used for initial determination of text within a given text section. Additionally, a text processing dictionary may be used for correlating character traits with characters or for correlating sound effects with a given text section or comic frame. For example, where captured text includes a term such as “Bark” and a dog is captured proximate to the given text section within a sequence of text sections, the term “Bark” may be identified within the text processing dictionary. The term “Bark” may be cross-correlated to a sound effect within a sound effects library stored within the sound effects library storage area 218 to identify one or more dog bark sounds for use as a sound effect in sequence during rendering of the comic. Further, where a character is identified to be a male character, a male voice envelope may be chosen for text sections associated with the identified male character of the comic. Many other possibilities exist for use of a text processing dictionary and sound effects for captured comic rendering and all are considered within the scope of the present subject matter.

It is understood that the memory 210 may include any combination of volatile and non-volatile memory suitable for the intended purpose, distributed or localized as appropriate, and may include other memory segments not illustrated within the present example for ease of illustration purposes. For example, the memory 210 may include a code storage area, an operating system storage area, a code execution area, and a data area without departure from the scope of the present subject matter.

A scanner device 222 and an optical processing module 224 are also illustrated. The optical processing module 224 controls the scanner device 222 for scanning of comic frames or other printed matter, and provides image recognition to identify text sections and comic characters within comic frames. The optical processing module 224 further performs optical character recognition (OCR) and graphic processing within the electronic comic rendering device 102, as described above and in more detail below. For example, the optical processing module 224 may identify characters, expressions on faces of characters (e.g., mood), shapes, objects, and other graphical elements within a scanned comic frame.

A comic processing module 226 is also illustrated and provides comic scanning and processing capabilities for the electronic comic rendering device 102, as also described above and in more detail below. The comic processing module 226 implements the automated electronic comic (e-comic) metadata processing of the electronic comic rendering device 102. The comic processing module 226 may utilize the scanner device 222 directly or via the optical processing module 224 for processing each text section of each comic frame. The comic processing module 226 may identify each section of text and each comic character within a given comic frame, may determine a sequence of the identified text sections, and may pass coordinate locations for each text section either directly to the scanner device 222 or to the optical processing module 224 for processing. The comic processing module 226 may assign comic character identifiers to the processed comic character images and associate the comic character identifiers with text sections to facilitate sequencing of audio output for rendering of a generated e-comic. In either implementation, the optical processing module 224 is invoked by the comic processing module 226 for image recognition processing of text within identified text sections and comic characters and may return processed text and comic character images to the comic processing module 226 for further processing as described above and in more detail below. It should further be understood that the comic processing module 226 may incorporate the scanner device 222 and/or the optical processing module 224 as part of its internal processing without departure from the scope of the present subject matter, as represented by the dashed outline within FIG. 2.

Though the scanner module 222, the optical processing module 224, and the comic processing module 226 are illustrated as a component-level modules for ease of illustration and description purposes, it should be noted that these modules may include any hardware, programmed processor(s), and memory used to carry out the respective functions of these modules as described above and in more detail below. For example, the scanner module 222, the optical processing module 224, and the comic processing module 226 may include additional controller circuitry in the form of application specific integrated circuits (ASICs), processors, and/or discrete integrated circuits and components for performing communication and electrical control activities associated with the respective devices. Additionally, the scanner module 222, the optical processing module 224, and the comic processing module 226 may also include interrupt-level, stack-level, and application-level modules as appropriate. Furthermore, the scanner module 222, the optical processing module 224, and the comic processing module 226 may include any memory components used for storage, execution, and data processing for performing processing activities associated with the module. The scanner module 222 may further include optical processing components for capturing information from a printed page.

It should also be noted that the optical processing module 224 and the comic processing module 226 may form a portion of other circuitry described without departure from the scope of the present subject matter. Further, the optical processing module 224 and the comic processing module 226 may alternatively be implemented as an application stored within the memory 210. In such an implementation, the optical processing module 224 and the comic processing module 226 may include instructions executed by the processor 200 for performing the functionality described herein. The processor 200 may execute these instructions to provide the processing capabilities described above and in more detail below for the electronic comic rendering device 102. The optical processing module 224 and the comic processing module 226 may form a portion of an interrupt service routine (ISR), a portion of an operating system, a portion of a browser application, or a portion of a separate application without departure from the scope of the present subject matter.

The processor 200, the display device 202, the input device 204, the audio output device 206, the communication module 208, the memory 210, the scanner device 222, the optical processing module 224, and the comic processing module 226 are interconnected via one or more interconnections shown as interconnection 228 for ease of illustration. The interconnection 228 may include a system bus, a network, or any other interconnection capable of providing the respective components with suitable interconnection for the respective purpose.

Furthermore, components within the electronic comic rendering device 102 may be co-located or distributed within a network without departure from the scope of the present subject matter. For example, the components within the electronic comic rendering device 102 may be located within a stand-alone device, such as a personal computer (e.g., desktop or laptop) or handheld device (e.g., cellular telephone, personal digital assistant (PDA), tablet computer, E-book, email device, music recording or playback device, etc.). For a distributed arrangement, the scanner device 222, the display device 202, and the input device 204 may be located at a kiosk, while the processor 200, memory 210, the optical processing module 224 and the comic processing module 226 may be located at a local or remote server. Many other possible arrangements for the components of the electronic comic rendering device 102 are possible and all are considered within the scope of the present subject matter.

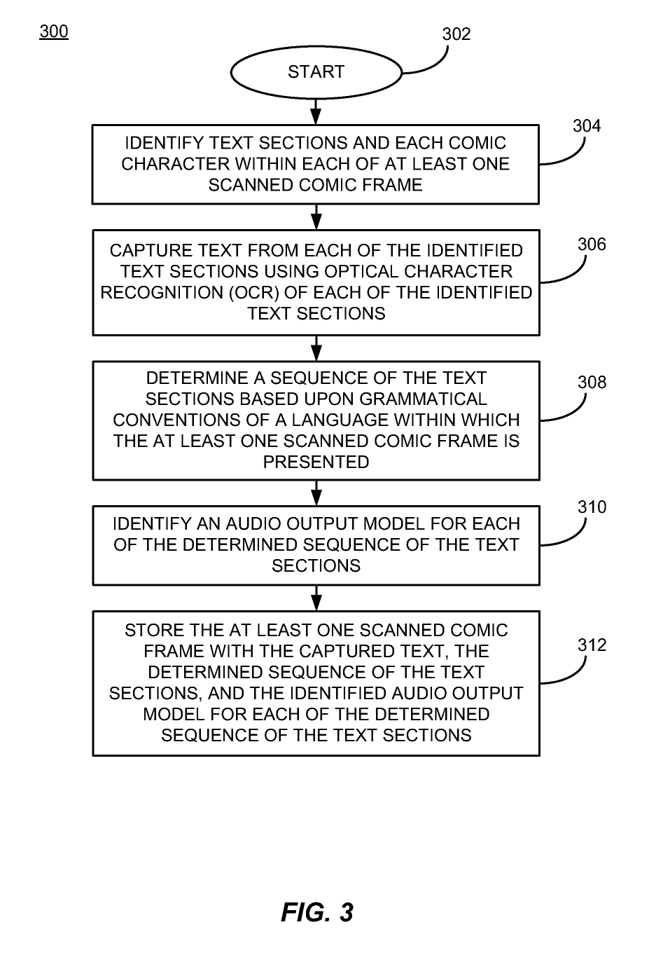

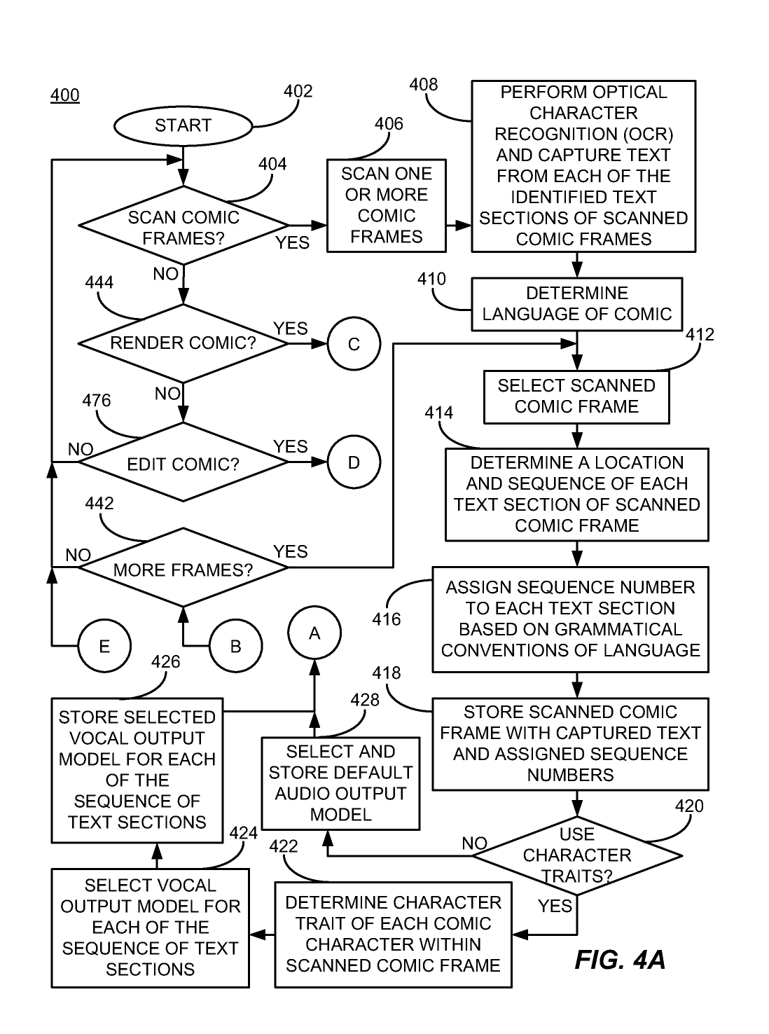

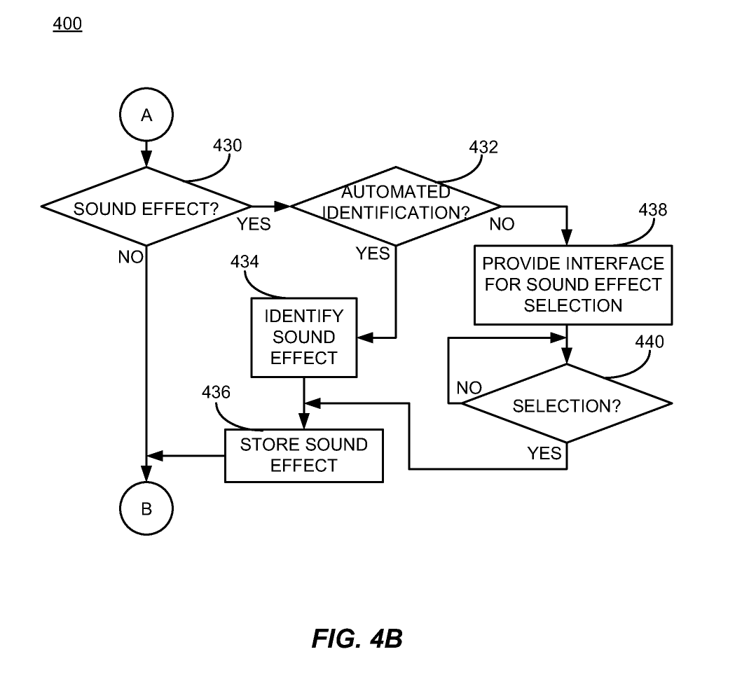

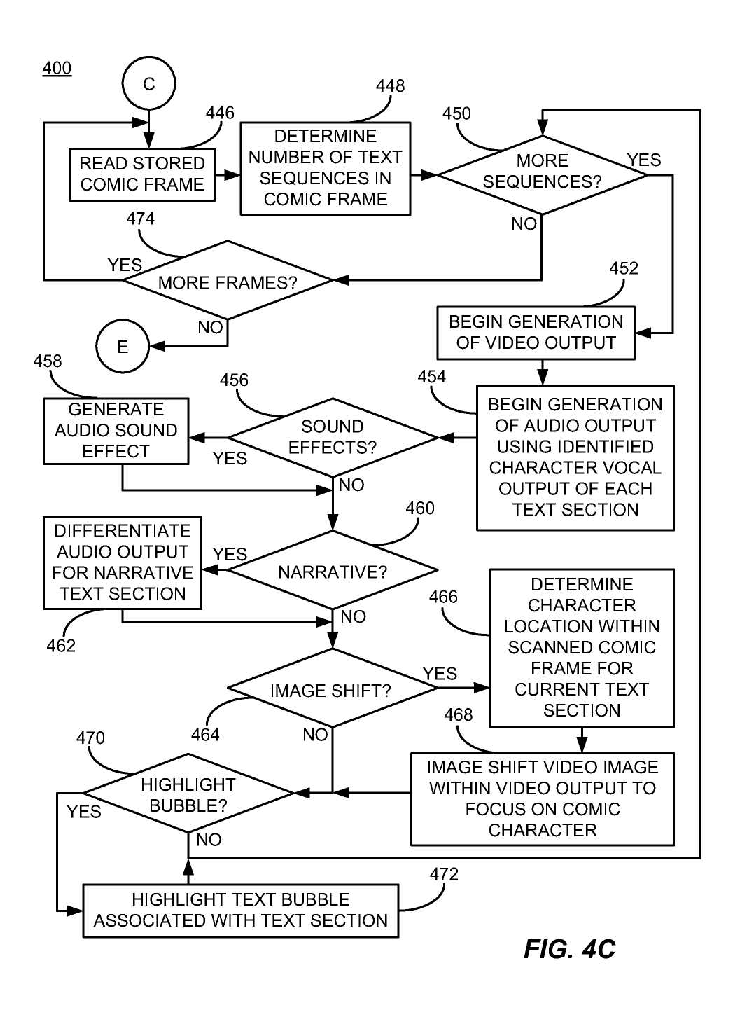

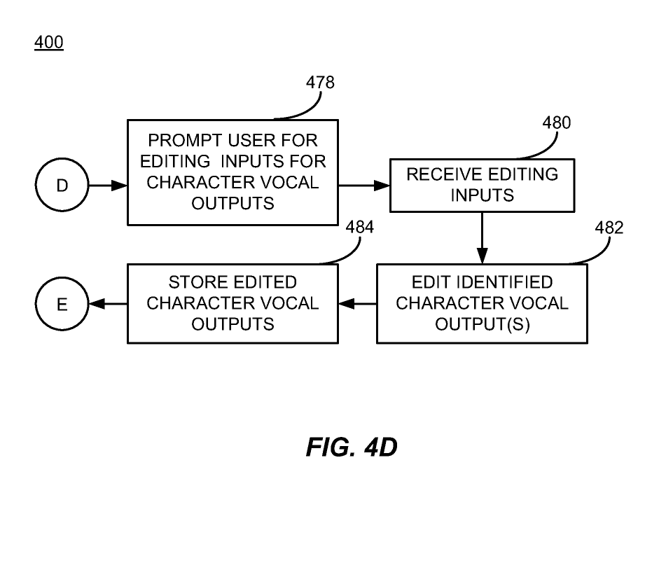

FIG. 3 through FIG. 4D below describe example processes that may be executed by devices, such as the electronic comic rendering device 102, to perform the automated electronic comic (e-comic) metadata processing associated with the present subject matter. Many other variations on the example processes are possible and all are considered within the scope of the present subject matter. The example processes may be performed by modules, such as the comic processing module 226 and/or executed by the processor 200, associated with such devices. It should be noted that time out procedures and other error control procedures are not illustrated within the example processes described below for ease of illustration purposes. However, it is understood that all such procedures are considered to be within the scope of the present subject matter.

FIG. 3 is a flow chart of an example of an implementation of a process 300 that provides automated electronic comic (e-comic) metadata processing. The process 300 starts at 302. At block 304, the process 300 identifies text sections and each comic character within each of at least one scanned comic frame. At block 306, the process 300 captures text from each of the identified text sections using optical character recognition (OCR) of each of the identified text sections. At block 308, the process 300 determines a sequence of the text sections based upon grammatical conventions of a language within which the at least one scanned comic frame is presented. At block 310, the process 300 identifies an audio output model for each of the determined sequence of the text sections. At block 312, the process 300 stores the at least one scanned comic frame with the captured text, the determined sequence of the text sections, and the identified audio output model for each of the determined sequence of the text sections.

FIGS. 4A-4D illustrate a flow chart of an example of an implementation of the process 400 for automated electronic comic (e-comic) metadata processing. FIG. 4A illustrates initial processing within the process 400. The process 400 starts at 402. At decision point 404, the process 400 begins iterative higher-level processing by determining whether a request to scan at least one comic frame has been received. It should be understood that description of additional higher-level decisions will be described in association with their respective processing for ease of description purposes and as such will be deferred and described further below. In response to a determination at decision point 404 that a request to scan at least one comic frame has been received, the process 400 scans one or more comic frames at block 406. At block 408, the process 400 performs optical character recognition (OCR) and captures text from each of the identified text sections of the scanned comic frame(s). At block 410, the process 400 determines the language of the text sections of the scanned comic frame(s). It should be understood that determining a language of a text section may include determining grammatical conventions of a language such as, for example, English, Japanese, or other languages, as described above. At block 412, the process 400 begins iterative processing of each scanned frame and selects a scanned comic frame for processing.

At block 414, the process 400 determines a location and sequence of each text section of the scanned comic frame. The location and sequence may be based upon grammatical conventions of the determined language of the text sections of the scanned comic frame. For example, determining the location and sequence of each text section may include determining a location of each text section within the scanned comic frame and determining that the text sections of the scanned comic frame utilize a left-to-right followed by a top-to-bottom grammatical convention when the language of the comic is, for example, English. Alternatively, determining the location and sequence of each text section may include determining a location of each text section within the scanned comic frame and determining that the text sections of the scanned comic frame utilize a right-to-left followed by a top-to-bottom grammatical convention when the language is, for example, Japanese (e.g., Mangas). At block 416, the process 400 assigns a sequence number to each text section based on grammatical conventions of the language. At block 418, the process 400 stores the scanned comic frame with the captured text and the assigned sequence numbers that identify the determined sequence of text sections within the scanned comic frame.

At decision point 420, the process 400 makes a determination as to whether to use character traits in association with comic characters within the scanned comic frame. In response to determining to use character traits in association with comic characters within the scanned comic frame at decision point 420, the process 400 determines character traits of each character within the scanned comic frame at block 422. The determination of the character traits of each comic character within the scanned comic frame may be made, for example, using additional optical recognition processing of the scanned comic frame to identify graphical representations of each comic character within the scanned comic frame. For example, determining the character traits of each comic character within the scanned comic frame may include determining whether a comic character within the scanned comic frame for each of the determined sequences of the text sections is a male character, a female character, a canine character, a feline character, etc. At block 424, the process 400 selects/identifies an audio output model for each of the sequence of text sections. Selection of an audio output model for each of the sequence of text sections may be based upon the determined character trait of each comic character within the scanned comic frame for each of the determined sequence of the text sections and a character vocal output model may be selected based upon the determined character trait. Selection of an audio output model may also include selection of one of a plurality of voice frequency envelopes for each of the determined sequence of the text sections based upon a determination of a species or gender, selection of a character-based audio-output based upon a determination of a species or gender, selection of a vocal inflection for automated voice output based upon automated interpretation of mood of a character, and other selections of audio output models as appropriate for a given comic character.

For example, a male vocal output model may be selected for at least one of the determined sequence of the text sections in response to determining, using the determined character trait, that a comic character associated with a given text section represents a male character within the at least one scanned comic frame. Similar processing may be performed for selecting a female, canine, feline, avian, or other vocal output model in response to determining, using the determined character trait, that a comic character associated with a given text section represents a female, canine, feline, avian, or other character, respectively within the at least one scanned comic frame. Mood may be interpreted from posture of the graphical character, punctuation (e.g., exclamation points or question marks), or other indicia within the scanned comic frame. Further, an automated vocal model may be assigned for each determined sequence of the text sections. Other audio output models based upon determined character traits are possible and all are considered within the scope of the present subject matter. At block 426, the process 400 stores the selected vocal output model for each of the sequence of text sections.

Returning to the description of decision point 420, in response to determining not to use character traits in association with comic characters within the scanned comic frame, the process 400 selects and stores a default audio output model at block 428. In response to storing the selected vocal output model for the text sequence within the scanned comic frame at block 426, or in response to selecting and storing the default audio output model at block 428, the process 400 transitions to the processing shown and described in association with FIG. 4B.

FIG. 4B is a flow chart of an example of an implementation of a first portion of additional processing associated with the process 400 for automated electronic comic (e-comic) metadata processing. At decision point 430, the process 400 makes a determination as to whether at least one of the text sections within the scanned comic frame comprises text indicative of a sound (e.g., the text “Bang,” “Thump,” “Bark,” etc.). In response to determining that at least one of the text sections within the scanned comic frame comprises text indicative of a sound, the process 400 makes a determination at decision point 432 as to whether to perform automated identification of a sound effect as audio output for the indicated sound or to prompt a user for sound effect selection. It is understood that the determination of whether to perform automated identification of the sound effect or to prompt a user for sound effect selection may be a configuration option as appropriate for a given implementation. In response to determining to perform automated identification of the sound effect, the process 400 identifies the sound effect at block 434. Automated identification of a sound effect may include determining that the text indicative of the sound is cross-referenced to a sound effect within a sound effects library via a captured text processing dictionary and selecting/obtaining the determined sound effect from the sound effects library. In addition, the sound effect may be obtained from the sound effects library and may involve sending a request for the sound effect to a server that stores the sound effects library and receiving the sound effect from the server. The sound effects library may be cross-referenced with character action information. Further, determining the sound effect cross-referenced within the captured text processing dictionary may involve selecting the sound effect based upon character action of a character associated with each of the determined sequence of text sections. Additionally, searches may be performed for additional sound effects via one or more additional sound effects libraries, such as via one or more of the server_1 106 through the server_N 108, and additional or alternative sound effects may be received and processed. At block 436, the process 400 stores the identified sound effect(s) and/or sound effects libraries. The identified sound effect(s) and/or sound effects libraries may be stored, for example, within the sound effects library storage area 218 of the memory 210. Cross references may be created for one or more captured text processing dictionaries to associate sound effects with text identified within a text section. As such, obtained sound effects may be stored locally to enhance a locally-stored sound effects library and captured text processing dictionary.

Returning to the description of decision point 432, in response to determining not to perform automated identification of the sound effect and to prompt a user for sound effect selection, the process 400 provides an interface, such as via the display 202 and the input device 204, for selection of a sound effect from a sound effects library for the scanned comic frame at block 438. At decision point 440, the process 400 makes a determination as to whether a selection of a sound effect from the sound effects library via the provided interface has been detected. In response to determining that a selection of a sound effect from the sound effects library has been detected at decision point 440, the process 400 continues to the processing described above in association with block 436 and stores the sound effect(s).

In response to either determining that at least one of the text sections within the scanned comic frame does not comprise text indicative of a sound at decision point 430 or in response to storing one or more sound effects at block 436, the process 400 transitions back to the higher level processing shown and described in association with decision point 442 within FIG. 4A.

At decision point 442, the process 400 makes a determination as to whether additional scanned comic frames are available for processing. In response to determining that additional scanned comic frames are available for processing, the process 400 returns to block 412 and iterates as described below until all available scanned comic frames have been processed. In response to determining that all scanned comic frames have been processed (e.g., no additional scanned comic frames are available for processing) at decision point 442, the process 400 returns to decision point 404 to determine whether a new request to scan at least one comic frame has been received, and iterates as described above.

Returning to the description of decision point 404, in response to determining that a new request to scan at least one comic frame has not been received, the process 400 makes a determination within the higher level process at decision point 444 as to whether a request to render a stored scanned comic frame has been received. In response to determining that a request to render a stored scanned comic frame has been received, the process 400 transitions to the processing shown and described in association with FIG. 4C.

FIG. 4C is a flow chart of an example of an implementation of a second portion of additional processing associated with the process 400 for automated electronic comic (e-comic) metadata processing. At block 446, the process 400 reads a stored scanned comic frame, including the captured text, the determined sequence of the text sections, and any identified audio output model for each of the determined sequence of the text sections. At block 448, the process 400 determines the number of text sequences in the scanned comic frame. At decision point 450, the process 400 makes a determination as to whether more text sequences are present in the scanned comic frame. For purposes of the present example, it is assumed that at least one text sequence is present in the scanned comic frame and that this decision with result in an affirmative determination for at least the first iteration of the processing described. In response to determining that at least one text sequence is present, the process 400 begins generation of video output using the at least one scanned comic frame at block 452. At block 454, the process 400 begins generation of audio output based upon the identified audio output model in the determined sequence of the text sections.

At decision point 456, the process 400 makes a determination as to whether any sound effects are associated within the scanned comic frame and have been selected. As described above, sound effects may be selected from an available sound effects library that is either stored locally or retrieved from a server. In response to determining that sound effects are associated with the scanned comic frame and have been selected, the process 400 generates audio output based upon the identified audio output model for the scanned comic frame using the selected sound effect(s) at block 458. In response to determining that no sound effects are associated with the scanned comic frame at decision point 456, or in response to generating the audio output based upon the identified audio output model using the selected sound effect(s) at block 458, the process 400 makes a determination at decision point 460 as to whether at least one of the determined text sequences includes a narrative text section. In response to determining that at least one of the determined text sequences includes a narrative text section, the process 400 differentiates the audio output for the narrative text section at block 462. For purposes of example, audio output for a narrative text section may include enhancing an automated or recorded voice to replicate that of an announcer, celebrity, or other style of audio output.

In response to determining that the current text sequence does not include a narrative text section at decision point 460, or in response to differentiating the audio output for the narrative text section at block 462, the process 400 makes a determination at decision point 464 as to whether to image shift a video image within the generated video output. Image shifting may be performed to enhance the comic output experience. For example, image shifting of a video image within the generated video output may include image shifting to bring a comic character toward a center of an output frame for at least one generated audio output segment. In response to determining to image shift a video image within the generated video output, the process 400 determines the comic character location within the scanned comic frame for the current text section at block 466. At block 468, the process 400 image shifts the video image (e.g., brings the comic character towards the center of the current output frame) within the video output to focus on and enhance the comic character within the given scene of the comic.

In response to determining not to image shift the video image within the generated video output at decision point 464, or in response to image shifting the video image within the video output at block 468, the process 400 makes a determination at decision point 470 as to whether to highlight a text bubble for the scanned comic frame associated with the current sequenced text section. In response to a determination to highlight the text bubble, the process 400 highlights the text bubble associated with the respective sequenced text section at block 472. In response to determining not to highlight a text bubble for the scanned comic frame at decision point 470, or in response to highlighting the text bubble at block 472, the process 400 returns to decision point 450 and iterates as described above.

Returning to the description of decision point 450, in response to determining that there are no more sequenced text sections for rendering within the current scanned comic frame, the process 400 makes a determination at decision point 474 as to whether more stored scanned comic frames are available for rendering. In response to determining that at least one more scanned comic frame is available for processing, the process 400 returns to block 446 to read the next scanned comic frame and iterates as described above. In response to determining that no additional scanned comic frames are available for processing at decision point 474, the process 400 transitions back to the higher level processing shown and described in association with decision point 404 within FIG. 4A and iterates as described above.

Returning to the description of decision point 444, in response to determining that a request to render a stored scanned comic frame has not been detected, the process 400 makes a determination within the higher level processing at decision point 476 as to whether a request to edit a scanned comic has been detected. For example, the processing at decision point 476 may include detecting a request to edit an identified audio output model for at least one of the determined sequence of the text sections, or a request for other editing as appropriate for a given implementation. In response to determining that a request to edit a scanned comic has been detected, the process 400 transitions to the processing shown and described in association with FIG. 4D.

FIG. 4D is a flow chart of an example of an implementation of a third portion of additional processing associated with the process 400 for automated electronic comic (e-comic) metadata processing. At block 478, the process 400 prompts a user for editing inputs for audio output model(s) for at least one of the determined sequence of the text sections. At block 480, the process 400 receives the editing inputs. At block 482, the process 400 edits the identified audio output model(s). At block 484, the process 400 stores the edited audio output model(s), such as to the sequence information storage area 216 within the memory 210. The process 400 transitions back to the higher level processing shown and described in association with decision point 404 within FIG. 4A and iterates as described above.

Returning to the description of decision point 476, in response to determining that a request to edit a scanned comic has been detected has not been detected, the process 400 returns to decision point 404 and iterates as described above.

As such, the process 400 provides one example of processing for scanning comic frames and assigning sequence information to each text section within each comic frame. Character traits may be automatically identified and processed to enhance the scanned comic rendering processing to add depth to characters in the form of audio output processing and comic character voice selection. Sound effects may be added either automatically in response to character trait identification or a user may be prompted for entry of sound effects. Editing of scanned comics and audio output is also provided to further enhance rendering of scanned comics. Many additional possibilities exist for automated electronic comic (e-comic) metadata processing and all are considered within the scope of the present subject matter.

Thus, in accord with certain implementations, a method of adding audio metadata to scanned comic images involves identifying text sections and each comic character within each of at least one scanned comic frame; capturing text from each of the identified text sections using optical character recognition (OCR) of each of the identified text sections; determining a location of each of the text sections within the at least one scanned comic frame; determining a sequence of the text sections based upon grammatical conventions of a language within which the at least one scanned comic frame is presented; assigning a sequence number to each text section, where an order of assigning the sequence number to each text section includes a left-to-right and top-to-bottom order where the language is English and includes a right-to-left and top-to-bottom where the language is Japanese; identifying an audio output model for each of the determined sequence of the text sections; storing the at least one scanned comic frame with the captured text, the assigned sequence number of each text section, and the identified audio output model for each of the determined sequence of the text sections; reading the stored at least one scanned comic frame, the captured text, the assigned sequence number of each text section, and the identified audio output model for each of the determined sequence of the text sections; generating video output using the at least one scanned comic frame; and generating, in the determined sequence of the text sections using the assigned sequence number of each text section, audio output based upon the captured text using the identified audio output model for each of the determined sequence of the text sections.

In certain implementations, the method of adding audio metadata to scanned comic images involves identifying text sections and each comic character within each of at least one scanned comic frame; capturing text from each of the identified text sections using optical character recognition (OCR) of each of the identified text sections; determining a sequence of the text sections based upon grammatical conventions of a language within which the at least one scanned comic frame is presented; identifying an audio output model for each of the determined sequence of the text sections; and storing the at least one scanned comic frame with the captured text, the determined sequence of the text sections, and the identified audio output model for each of the determined sequence of the text sections.

In certain implementations, the method of adding audio metadata to scanned comic images involving determining the sequence of the text sections based upon grammatical conventions of the language within which the at least one scanned comic frame is presented involves determining a location of each of the text sections within the at least one scanned comic frame; assigning a sequence number to each text section in an order of left-to-right and top-to-bottom where the language is English; and assigning the sequence number to each text section in an order of right-to-left and top-to-bottom where the language is Japanese. In certain implementations, the method of storing the at least one scanned comic frame with the captured text, the determined sequence of the text sections, and the identified audio output model for each of the determined sequence of the text sections involves storing the at least one scanned comic frame with the captured text, each assigned sequence number, and the identified audio output model for each of the determined sequence of the text sections. In certain implementations, the method further involves determining a character trait of each comic character within the at least one scanned comic frame; and the method of identifying the audio output model for each of the determined sequence of the text sections involves selecting a character vocal output model based upon the determined character trait of each comic character within the at least one scanned comic frame for each of the determined sequence of the text sections. In certain implementations, the method of identifying the audio output model for each of the determined sequence of the text sections involves selecting one of a plurality of voice frequency envelopes for each of the determined sequence of the text sections based upon a determination of one of a species and a gender of the comic character associated with at least one of the determined sequence of the text sections. In certain implementations, the method of identifying the audio output model for each of the determined sequence of the text sections involves identifying a vocal inflection for automated voice output based upon automated interpretation of a mood of the comic character associated with at least one of the determined sequence of the text sections. In certain implementations, the method further involves reading the stored at least one scanned comic frame, the captured text, the determined sequence of the text sections, and the identified audio output model for each of the determined sequence of the text sections; generating video output using the at least one scanned comic frame; and generating, in the determined sequence of the text sections, audio output based upon the captured text using the identified audio output model for each of the determined sequence of the text sections. In certain implementations, the method of generating the video output using the at least one scanned comic frame involves determining a comic character location within at least one of the at least one scanned comic frame for at least one of the determined sequence of the text sections; and image shifting a video image within the video output to bring the comic character toward a center of an output frame for at least one generated audio output segment. In certain implementations, the method of generating the video output using the at least one scanned comic frame involves highlighting a text bubble for at least one of the at least one scanned comic frame associated with a respective portion of the generated audio output as the generated video output and the generated audio output progresses. In certain implementations, the method of generating, in the determined sequence of the text sections, audio output based upon the identified audio output model for each of the determined sequence of the text sections involves determining that at least one of the at least one of the determined sequence of text sections includes a narrative text section; and differentiating the audio output for the narrative text section. In certain implementations, at least one of the text sections includes text indicative of a sound, and the method further involves determining that the text indicative of the sound is cross-referenced to a sound effect within a sound effects library via a captured text processing dictionary; selecting the sound effect from the sounds effects library; and generating audio output based upon the identified audio output model for the one of the at least one scanned comic frame using the selected sound effect. In certain implementations, the method further involves detecting a request to edit the identified audio output model for at least one of the determined sequence of the text sections; prompting for editing inputs for the identified audio output model for the at least one of the determined sequence of the text sections; receiving the editing inputs for the identified audio output model for the at least one of the determined sequence of the text sections; editing the identified audio output model for the at least one of the determined sequence of the text sections; and storing the edited audio output model for the at least one of the determined sequence of the text sections.

In another implementation, a computer readable storage medium may store instructions which, when executed on one or more programmed processors, carry out a process of adding audio metadata to scanned comic images involving identifying text sections and each comic character within each of at least one scanned comic frame; capturing text from each of the identified text sections using optical character recognition (OCR) of each of the identified text sections; determining a sequence of the text sections based upon grammatical conventions of a language within which the at least one scanned comic frame is presented; identifying an audio output model for each of the determined sequence of the text sections; and storing the at least one scanned comic frame with the captured text, the determined sequence of the text sections, and the identified audio output model for each of the determined sequence of the text sections.

An apparatus for adding audio metadata to scanned comic images, consistent with certain implementations, has a memory and a processor programmed to identify text sections and each comic character within each of at least one scanned comic frame; capture text from each of the identified text sections using optical character recognition (OCR) of each of the identified text sections; determine a sequence of the text sections based upon grammatical conventions of a language within which the at least one scanned comic frame is presented; identify an audio output model for each of the determined sequence of the text sections; and store the at least one scanned comic frame with the captured text, the determined sequence of the text sections, and the identified audio output model for each of the determined sequence of the text sections within the memory.

In certain implementations, in being programmed to determine the sequence of the text sections based upon grammatical conventions of the language within which the at least one scanned comic frame is presented, the processor is programmed to determine a location of each of the text sections within the at least one scanned comic frame; assign a sequence number to each text section in an order of left-to-right and top-to-bottom where the language is English; and assign the sequence number to each text section in an order of right-to-left and top-to-bottom where the language is Japanese. In certain implementations, in being programmed to store the at least one scanned comic frame with the captured text, the determined sequence of the text sections, and the identified audio output model for each of the determined sequence of the text sections within the memory, the processor is programmed to store the at least one scanned comic frame with the captured text, each assigned sequence number, and the identified audio output model for each of the determined sequence of the text sections within the memory. In certain implementations, the processor is further programmed to determine a character trait of each comic character within the at least one scanned comic frame; and where, in being programmed to identify the audio output model for each of the determined sequence of the text sections, the processor is programmed to select a character vocal output model based upon the determined character trait of each comic character within the at least one scanned comic frame for each of the determined sequence of the text sections. In certain implementations, in being programmed to identify the audio output model for each of the determined sequence of the text sections, the processor is programmed to select one of a plurality of voice frequency envelopes for each of the determined sequence of the text sections based upon a determination of one of a species and a gender of the comic character associated with at least one of the determined sequence of the text sections. In certain implementations, in being programmed to identify the audio output model for each of the determined sequence of the text sections, the processor is programmed to identify a vocal inflection for automated voice output based upon automated interpretation of a mood of the comic character associated with at least one of the determined sequence of the text sections. In certain implementations, the processor is further programmed to read the stored at least one scanned comic frame, the captured text, the determined sequence of the text sections, and the identified audio output model for each of the determined sequence of the text sections; generate video output using the at least one scanned comic frame; and generate, in the determined sequence of the text sections, audio output based upon the captured text using the identified audio output model for each of the determined sequence of the text sections. In certain implementations, in being programmed to generate the video output using the at least one scanned comic frame, the processor is programmed to determine a comic character location within at least one of the at least one scanned comic frame for at least one of the determined sequence of the text sections; and image shift a video image within the video output to bring the comic character toward a center of an output frame for at least one generated audio output segment. In certain implementations, in being programmed to generate the video output using the at least one scanned comic frame, the processor is programmed to highlight a text bubble for at least one of the at least one scanned comic frame associated with a respective portion of the generated audio output as the generated video output and the generated audio output progresses. In certain implementations, in being programmed to generate, in the determined sequence of the text sections, audio output based upon the identified audio output model for each of the determined sequence of the text sections, the processor is programmed to determine that at least one of the at least one of the determined sequence of text sections includes a narrative text section; and differentiate the audio output for the narrative text section. In certain implementations, at least one of the text sections includes text indicative of a sound, and where the processor is further programmed to determine that the text indicative of the sound is cross-referenced to a sound effect within a sound effects library via a captured text processing dictionary; select the sound effect from the sounds effects library; and generate audio output based upon the identified audio output model for the one of the at least one scanned comic frame using the selected sound effect. In certain implementations, the processor is further programmed to detect a request to edit the identified audio output model for at least one of the determined sequence of the text sections; prompt for editing inputs for the identified audio output model for the at least one of the determined sequence of the text sections; receive the editing inputs for the identified audio output model for the at least one of the determined sequence of the text sections; edit the identified audio output model for the at least one of the determined sequence of the text sections; and store the edited audio output model for the at least one of the determined sequence of the text sections within the memory.

While certain embodiments herein were described in conjunction with specific circuitry that carries out the functions described, other embodiments are contemplated in which the circuit functions are carried out using equivalent elements executed on one or more programmed processors. General purpose computers, microprocessor based computers, micro-controllers, optical computers, analog computers, dedicated processors, application specific circuits and/or dedicated hard wired logic and analog circuitry may be used to construct alternative equivalent embodiments. Other embodiments could be implemented using hardware component equivalents such as special purpose hardware, dedicated processors or combinations thereof.

Certain embodiments may be implemented using one or more programmed processors executing programming instructions that in certain instances are broadly described above in flow chart form that can be stored on any suitable electronic or computer readable storage medium (such as, for example, disc storage, Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies). However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

While certain illustrative embodiments have been described, it is evident that many alternatives, modifications, permutations and variations will become apparent to those skilled in the art in light of the foregoing description.

What is claimed is:

1. A method of adding audio metadata to scanned comic images, comprising:
identifying text sections and each comic character within each of at least one scanned comic frame;
capturing text from each of the identified text sections using optical character recognition (OCR) of each of the identified text sections;
determining a location of each of the text sections within the at least one scanned comic frame;
determining a sequence of the text sections based upon grammatical conventions of a language within which the at least one scanned comic frame is presented;
assigning a sequence number to each text section, where an order of assigning the sequence number to each text section comprises a left-to-right and top-to-bottom order where the language is English and comprises a right-to-left and top-to-bottom where the language is Japanese;
identifying an audio output model for each of the determined sequence of the text sections;
storing the at least one scanned comic frame with the captured text, the assigned sequence number of each text section, and the identified audio output model for each of the determined sequence of the text sections;
reading the stored at least one scanned comic frame, the captured text, the assigned sequence number of each text section, and the identified audio output model for each of the determined sequence of the text sections;
generating video output using the at least one scanned comic frame; and
generating, in the determined sequence of the text sections using the assigned sequence number of each text section, audio output based upon the captured text using the identified audio output model for each of the determined sequence of the text sections.

2. A method of adding audio metadata to scanned comic images, comprising:
identifying text sections and each comic character within each of at least one scanned comic frame;
capturing text from each of the identified text sections using optical character recognition (OCR) of each of the identified text sections;
determining a sequence of the text sections based upon grammatical conventions of a language within which the at least one scanned comic frame is presented;
identifying an audio output model for each of the determined sequence of the text sections; and
storing the at least one scanned comic frame with the captured text, the determined sequence of the text sections, and the identified audio output model for each of the determined sequence of the text sections.

3. The method according to claim 2, where determining the sequence of the text sections based upon grammatical conventions of the language within which the at least one scanned comic frame is presented comprises:
determining a location of each of the text sections within the at least one scanned comic frame;
assigning a sequence number to each text section in an order of left-to-right and top-to-bottom where the language is English; and
assigning the sequence number to each text section in an order of right-to-left and top-to-bottom where the language is Japanese.

4. The method according to claim 3, where storing the at least one scanned comic frame with the captured text, the determined sequence of the text sections, and the identified audio output model for each of the determined sequence of the text sections comprises storing the at least one scanned comic frame with the captured text, each assigned sequence number, and the identified audio output model for each of the determined sequence of the text sections.

5. The method according to claim 2, further comprising:
determining a character trait of each comic character within the at least one scanned comic frame; and
where identifying the audio output model for each of the determined sequence of the text sections comprises:
selecting a character vocal output model based upon the determined character trait of each comic character within the at least one scanned comic frame for each of the determined sequence of the text sections.

6. The method according to claim 2, where identifying the audio output model for each of the determined sequence of the text sections comprises selecting one of a plurality of voice frequency envelopes for each of the determined sequence of the text sections based upon a determination of one of a species and a gender of the comic character associated with at least one of the determined sequence of the text sections.

7. The method according to claim 2, where identifying the audio output model for each of the determined sequence of the text sections comprises identifying a vocal inflection for automated voice output based upon automated interpretation of a mood of the comic character associated with at least one of the determined sequence of the text sections.

8. The method according to claim 2, further comprising:
reading the stored at least one scanned comic frame, the captured text, the determined sequence of the text sections, and the identified audio output model for each of the determined sequence of the text sections;
generating video output using the at least one scanned comic frame; and
generating, in the determined sequence of the text sections, audio output based upon the captured text using the identified audio output model for each of the determined sequence of the text sections.

9. The method according to claim 8, where generating the video output using the at least one scanned comic frame comprises:
determining a comic character location within at least one of the at least one scanned comic frame for at least one of the determined sequence of the text sections; and
image shifting a video image within the video output to bring the comic character toward a center of an output frame for at least one generated audio output segment.

10. The method according to claim 8, where generating the video output using the at least one scanned comic frame comprises:
highlighting a text bubble for at least one of the at least one scanned comic frame associated with a respective portion of the generated audio output as the generated video output and the generated audio output progresses.

11. The method according to claim 8, where generating, in the determined sequence of the text sections, audio output based upon the identified audio output model for each of the determined sequence of the text sections comprises:
determining that at least one of the at least one of the determined sequence of text sections comprises a narrative text section; and
differentiating the audio output for the narrative text section.

12. The method according to claim 2, where at least one of the text sections comprises text indicative of a sound, and further comprising:
determining that the text indicative of the sound is cross-referenced to a sound effect within a sound effects library via a captured text processing dictionary;
selecting the sound effect from the sounds effects library; and
generating audio output based upon the identified audio output model for the one of the at least one scanned comic frame using the selected sound effect.

13. The method according to claim 2, further comprising:
detecting a request to edit the identified audio output model for at least one of the determined sequence of the text sections;
prompting for editing inputs for the identified audio output model for the at least one of the determined sequence of the text sections;
receiving the editing inputs for the identified audio output model for the at least one of the determined sequence of the text sections;
editing the identified audio output model for the at least one of the determined sequence of the text sections; and
storing the edited audio output model for the at least one of the determined sequence of the text sections.

14. A computer readable storage medium storing instructions which, when executed on one or more programmed processors, carry out a method according to claim 2.

15. An apparatus for adding audio metadata to scanned comic images, comprising:
a memory; and
a processor programmed to:
identify text sections and each comic character within each of at least one scanned comic frame;
capture text from each of the identified text sections using optical character recognition (OCR) of each of the identified text sections;
determine a sequence of the text sections based upon grammatical conventions of a language within which the at least one scanned comic frame is presented;
identify an audio output model for each of the determined sequence of the text sections; and
store the at least one scanned comic frame with the captured text, the determined sequence of the text sections, and the identified audio output model for each of the determined sequence of the text sections within the memory.

16. The apparatus according to claim 15, where, in being programmed to determine the sequence of the text sections based upon grammatical conventions of the language within which the at least one scanned comic frame is presented, the processor is programmed to:
determine a location of each of the text sections within the at least one scanned comic frame;
assign a sequence number to each text section in an order of left-to-right and top-to-bottom where the language is English; and
assign the sequence number to each text section in an order of right-to-left and top-to-bottom where the language is Japanese.

17. The apparatus according to claim 16, where, in being programmed to store the at least one scanned comic frame with the captured text, the determined sequence of the text sections, and the identified audio output model for each of the determined sequence of the text sections within the memory, the processor is programmed to store the at least one scanned comic frame with the captured text, each assigned sequence number, and the identified audio output model for each of the determined sequence of the text sections within the memory.

18. The apparatus according to claim 15, where, the processor is further programmed to:
determine a character trait of each comic character within the at least one scanned comic frame; and
where, in being programmed to identify the audio output model for each of the determined sequence of the text sections, the processor is programmed to:
select a character vocal output model based upon the determined character trait of each comic character within the at least one scanned comic frame for each of the determined sequence of the text sections.

19. The apparatus according to claim 15, where, in being programmed to identify the audio output model for each of the determined sequence of the text sections, the processor is programmed to select one of a plurality of voice frequency envelopes for each of the determined sequence of the text sections based upon a determination of one of a species and a gender of the comic character associated with at least one of the determined sequence of the text sections.

20. The apparatus according to claim 15, where, in being programmed to identify the audio output model for each of the determined sequence of the text sections, the processor is programmed to identify a vocal inflection for automated voice output based upon automated interpretation of a mood of the comic character associated with at least one of the determined sequence of the text sections.

21. The apparatus according to claim 15, where the processor is further programmed to:
read the stored at least one scanned comic frame, the captured text, the determined sequence of the text sections, and the identified audio output model for each of the determined sequence of the text sections;
generate video output using the at least one scanned comic frame; and
generate, in the determined sequence of the text sections, audio output based upon the captured text using the identified audio output model for each of the determined sequence of the text sections.

22. The apparatus according to claim 21, where, in being programmed to generate the video output using the at least one scanned comic frame, the processor is programmed to:
determine a comic character location within at least one of the at least one scanned comic frame for at least one of the determined sequence of the text sections; and
image shift a video image within the video output to bring the comic character toward a center of an output frame for at least one generated audio output segment.

23. The apparatus according to claim 21, where, in being programmed to generate the video output using the at least one scanned comic frame, the processor is programmed to:
highlight a text bubble for at least one of the at least one scanned comic frame associated with a respective portion of the generated audio output as the generated video output and the generated audio output progresses.

24. The apparatus according to claim 21, where, in being programmed to generate, in the determined sequence of the text sections, audio output based upon the identified audio output model for each of the determined sequence of the text sections, the processor is programmed to:
determine that at least one of the at least one of the determined sequence of text sections comprises a narrative text section; and
differentiate the audio output for the narrative text section.

25. The apparatus according to claim 15, where at least one of the text sections comprises text indicative of a sound, and where the processor is further programmed to:
determine that the text indicative of the sound is cross-referenced to a sound effect within a sound effects library via a captured text processing dictionary;
select the sound effect from the sounds effects library; and
generate audio output based upon the identified audio output model for the one of the at least one scanned comic frame using the selected sound effect.

26. The apparatus according to claim 15, where the processor is further programmed to:
detect a request to edit the identified audio output model for at least one of the determined sequence of the text sections;
prompt for editing inputs for the identified audio output model for the at least one of the determined sequence of the text sections;
receive the editing inputs for the identified audio output model for the at least one of the determined sequence of the text sections;
edit the identified audio output model for the at least one of the determined sequence of the text sections; and
store the edited audio output model for the at least one of the determined sequence of the text sections within the memory.
